(19) United States
(12) Patent Application Publication
(10) Pub. No.: US 2020/0042885 A1
(43) Pub. Date: Feb. 6, 2020

(54) SYSTEMS AND METHODS FOR DETERMINING AN ESTIMATED TIME OF ARRIVAL

(71) Applicant: BEIJING DIDI INFINITY TECHNOLOGY AND DEVELOPMENT CO., LTD., Beijing (CN)

(72) Inventors: Xiaowei ZHONG, Beijing (CN); Ziteng WANG, Beijing (CN); Fanlin MENG, Beijing (CN); Zheng WANG, Beijing (CN)

(73) Assignee: BEIJING DIDI INFINITY TECHNOLOGY AND DEVELOPMENT CO., LTD., Beijing (CN)

(21) Appl. No.: 16/596,830

(22) Filed: Oct. 9, 2019

Related U.S. Application Data
(63) Continuation of application No. PCT/CN2017/084496, filed on May 16, 2017.

(51) Int. Cl. G06N 5/04; G06N 20/00

(52) U.S. Cl. CPC G06N 5/04; G06N 20/00

(57) ABSTRACT

The present disclosure relates to systems and methods for determining an estimated time of arrival. The systems may perform the methods to operate logical circuits to obtain a departure location associated with a terminal device and information relating to the departure location. The information may include one or more service providers. The system may operate the logical circuits to obtain a trained machine learning model. The system may operate the logical circuits to determine an estimated time of arrival for one of the one or more service providers to arrive at the departure location based on the information and the machine learning model.

### CROSS-REFERENCE TO RELATED APPLICATION

This application is a continuation of International Application No. PCT/CN2017/084496, filed on May 16, 2017, designating the United States of America, the contents of which are hereby incorporated by reference in their entirety.

### TECHNICAL FIELD

This application relates generally to machine learning, and in particular, to a system and method for determining an estimated time of arrival (ETA) to arrive at a departure location.

### BACKGROUND

Online on-demand transportation services, such as online taxi hailing, become more and more popular. Generally, a user of a transportation service application platform, such as DiDi Chuxing™, hopes to have a more accurate estimated time of arrival (ETA) for picking up the user. Currently, the ETA for pickup is mostly determined based on a distance between the user and a service provider after the service provider has received a service request from the user. In such a condition, the user is not aware of a long ETA for pickup before a service is requested. Therefore, the user experience may be unsatisfying during using an online on-demand transportation service.

### SUMMARY

According to exemplary embodiments of the present disclosure, a system may include at least one computer-readable storage medium including a set of instructions for providing an on-demand service and at least one processor in communication with the computer-readable storage medium. When executing the set of instructions, the at least one processor may direct to perform one or more of the following operations. The at least one processor may operate logical circuits in the at least one processor to obtain a departure location associated with a terminal device. The at least one processor may operate the logical circuits in the at least one processor to obtain information relating to the departure location, the information including information of one or more service providers. The at least one processor may operate the logical circuits in the at least one processor to obtain a trained machine learning model. The at least one processor may operate the logical circuits in the at least one processor to determine an estimated time of arrival for the one or more service providers to arrive at the departure location based on the information and the trained machine learning model.

According to another aspect of the disclosure, a method may include one or more of the following operations. At least one device of an online on-demand service platform may have at least one processor. The at least one processor may operate logical circuits in the at least one processor to obtain a departure location associated with a terminal device. The at least one processor may operate the logical circuits in the at least one processor to obtain information relating to the departure location, the information including information of one or more service providers. The at least one processor may operate the logical circuits in the at least one processor to obtain a trained machine learning model. The at least one processor may operate the logical circuits in the at least one processor to determine an estimated time of arrival for the one or more service providers to arrive at the departure location based on the information and the trained machine learning model.

According to another aspect of the disclosure, a non-transitory machine-readable storage medium may include instructions. When the non-transitory machine-readable storage medium accessed by at least one processor of an online on-demand service platform from a requester terminal, the instructions may cause the at least one processor to perform one or more of the following operations. The instructions may cause the at least one processor to operate logical circuits in the at least one processor to obtain a departure location associated with a terminal device. The instructions may cause the at least one processor to operate the logical circuits in the at least one processor to obtain information relating to the departure location, the information including information of one or more service providers. The instructions may cause the at least one processor to operate the logical circuits in the at least one processor to obtain a trained machine learning model. The instructions may cause the at least one processor to operate the logical circuits in the at least one processor to determine an estimated time of arrival for the one or more service providers to arrive at the departure location based on the information and the trained machine learning model.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a block diagram of an exemplary on-demand service system according to some embodiments of the present disclosure;

FIG. 2 is a schematic diagram illustrating exemplary hardware and software components of a computing device according to some embodiments of the present disclosure;

FIG. 3 is an exemplary user interface on a terminal device of a servicer requester according to some embodiments of the present disclosure;

FIG. 4A is a block diagram of an exemplary processor according to some embodiments of the present disclosure;

FIG. 4B is a block diagram of an exemplary determination module according to some embodiments of the present disclosure;

FIG. 5 is a flow chart of an exemplary process for determining an ETA to arrive at a departure location according to some embodiments of the present disclosure;

FIG. 6 is a flow chart of an exemplary process for determining a trained machine learning model according to some embodiments of the present disclosure; and

FIG. 7 is a schematic diagram illustrating exemplary hardware and/or software components of an exemplary mobile device according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the system and method in the present disclosure is described primarily in regard to allocate a set of sharable orders, it should also be understood that this is only one exemplary embodiment. The system or method of the present disclosure may be applied to any other kind of on demand service. For example, the system or method of the present disclosure may be applied to transportation systems of different environments including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system for management and/or distribution, for example, a system for sending and/or receiving an express. The application of the system or method of the present disclosure may include a webpage, a plug-in of a browser, a client terminal, a custom system, an internal analysis system, an artificial intelligence robot, or the like, or any combination thereof.

The term “passenger,” “requester,” “service requester,” and “customer” in the present disclosure are used interchangeably to refer to an individual or, an entity or a tool that may request or order a service. Also, the term “driver,” “provider,” “service provider,” and “supplier” in the present disclosure are used interchangeably to refer to an individual or, an entity or a tool that may provide a service or facilitate the providing of the service. The term “user” in the present disclosure may refer to an individual, an entity or a tool that may request a service, order a service, provide a service, or facilitate the providing of the service. For example, the user may be a passenger, a driver, an operator, or the like, or any combination thereof. In the present disclosure, “passenger,” “user equipment,” “user terminal,” and “passenger terminal” may be used interchangeably, and “driver” and “driver terminal” may be used interchangeably.

The term “service request” and “order” in the present disclosure are used interchangeably to refer to a request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable or free.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

An aspect of the present disclosure relates to an online system and method for determining an ETA for pickup. To this end, the online on-demand transportation service platform may first obtain a departure location associated with a terminal device, and determine an estimated time of arrival for picking up a user at the departure location based on a trained machine learning model and information relating to the departure location. The trained machine learning model may be trained using a plurality of historical date relating to the on-demand transportation service. Thus, the present disclosure may provide a more accurate estimation of the ETA for pickup based on the information relating to the departure location using the trained machine learning model. The user can determine as to whether to request for a service based on the estimated ETA. A more accurate ETA estimation may improve the success ratio of car hailing orders and improve the user experience with the service.

It should be noted that, the technical problem and solution are rooted in online on-demand transportation service, which is a new form of service further rooted only in post-Internet era. It provides technical solutions to users (e.g., service requesters) and service providers (e.g., drivers) that could rise only in post-Internet era. In pre-Internet era, when a user hails a taxi on street, the taxi request and acceptance occur only between the passenger and one taxi driver that sees the passenger. If the passenger hails a taxi through telephone call, the service request and acceptance may occur only between the passenger and one service provider (e.g., one taxi company or agent). Besides, the ETA to arrive at a departure location is not available for a passenger. Online taxi, however, allows a user of the service to real-time and automatic distribute a service request to a vast number of individual service providers (e.g., taxi driver) distance away from the user. It also allows a plurality of service provides to respond to the service request simultaneously and in real-time. Besides, the ETA to arrive at a departure location is available for the online on-demand transportation system and the passenger. The passenger can determine whether to request for a service based on the ETA before sending a request. Therefore, through Internet, the online on-demand transportation systems may provide a much more efficient transaction platform for the users and the service providers that may never meet in a traditional pre-Internet transportation service system.

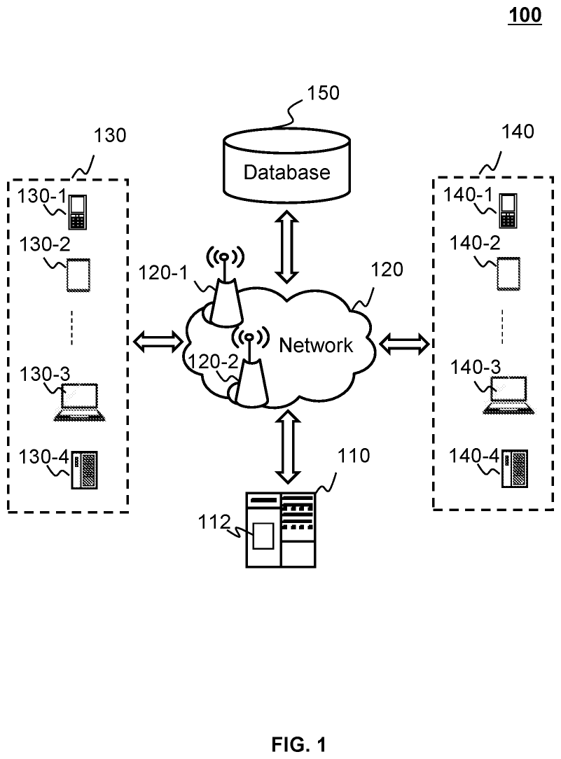

FIG. 1 is a block diagram of an exemplary on-demand service system 100 according to some embodiments. For example, the on-demand service system 100 may be an online transportation service platform for transportation services such as taxi hailing, chauffeur service, express car, carpool, bus service, driver hire and shuttle service. The on-demand service system 100 may be an online platform including a server 110, a network 120, a user equipment 130, a driver terminal 140, and a database 150. The server 110 may include a processing engine 112.

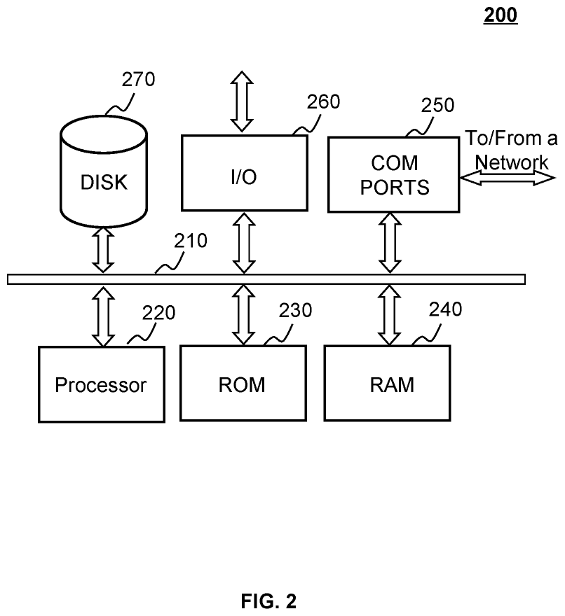

In some embodiments, the server 110 may be a single server, or a server group. The server group may be centralized, or distributed (e.g., the server 110 may be a distributed system). In some embodiments, the server 110 may be local or remote. For example, the server 110 may access information and/or data stored in the user equipment 130, the driver terminal 140, and/or the database 150 via the network 120. As another example, the server 110 may be directly connected to the user equipment 130, the driver terminal 140, and/or the database 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data relating to the service request to perform one or more functions described in the present disclosure. For example, the processing engine 112 may determine an ETA for pickup based on information relating to a departure location obtained from the user equipment 130. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the on-demand service system 100 (e.g., the server 110, the user equipment 130, the driver terminal 140, and the database 150) may send information and/or data to other component(s) in the on-demand service system 100 via the network 120. For example, the server 110 may transmit the ETA to the user equipment 130 via the network 120. In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the on-demand service system 100 may be connected to the network 120 to exchange data and/or information.

In some embodiments, a service requester may be a user of the user equipment 130. In some embodiments, the user of the user equipment 130 may be someone other than the service requester. For example, a user A of the user equipment 130 may use the user equipment 130 to send a service request for a user B, or receive service and/or information or instructions from the server 110. In some embodiments, a provider may be a user of the driver terminal 140. In some embodiments, the user of the driver terminal 140 may be someone other than the provider. For example, a user C of the driver terminal 140 may user the driver terminal 140 to receive a service request for a user D, and/or information or instructions from the server 110.

In some embodiments, the user equipment 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a Hololens, a Gear VR, etc. In some embodiments, built-in device in the motor vehicle 130-4 may include an onboard computer, an onboard television, etc. In some embodiments, the user equipment 130 may be a device for storing orders of the service requester and/or the user equipment 130. In some embodiments, the user equipment 130 may be a device with positioning technology for locating the position of the service requester and/or the user equipment 130.

In some embodiments, the driver terminal 140 may be similar to, or the same device as the user equipment 130. In some embodiments, the driver terminal 140 may be a device for storing orders of the driver and/or the driver terminal 140. In some embodiments, the driver terminal 140 may be a device with positioning technology for locating the position of the service provider and/or the driver terminal 140. In some embodiments, the user equipment 130 and/or the driver terminal 140 may communicate with other positioning device to determine the position of the service requester, the user equipment 130, the driver, and/or the driver terminal 140. In some embodiments, the user equipment 130 and/or the driver terminal 140 may send positioning information to the server 110.

The database 150 may store data and/or instructions. In some embodiments, the database 150 may store data obtained from the user equipment 130 and/or the driver terminal 140. In some embodiments, the database 150 may store information relating to a departure location associated with the user equipment 130 and/or the driver terminal 140. The information relating to the departure location may include service provider information, order information, or traffic information, in surrounding areas of the departure location. The database 150 may obtain the information relating to the departure location from a location based service application (e.g., a DiDi Chuxing™, etc), or a third party (e.g., a traffic departure, a map application, etc.) via the network 120. In some embodiments, the database 150 may store data and/or instructions that the server 110 may execute or use to perform exemplary methods described in the present disclosure. In some embodiments, database 150 may include a mass storage, a removable storage, a volatile read-and-write memory, a read-only memory (ROM), or the like, or any combination thereof. Exemplary mass storage may include a magnetic disk, an optical disk, a solid-state drives, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the database 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the database 150 may be connected to the network 120 to communicate with one or more components in the on-demand service system 100 (e.g., the server 110, the user equipment 130, the driver terminal 140, etc.). One or more components in the on-demand service system 100 may access the data or instructions stored in the database 150 via the network 120. In some embodiments, the database 150 may be directly connected to or communicate with one or more components in the on-demand service system 100 (e.g., the server 110, the user equipment 130, the driver terminal 140, etc.). In some embodiments, the database 150 may be part of the server 110.

In some embodiments, one or more components in the on-demand service system 100 (e.g., the server 110, the user equipment 130, the driver terminal 140, etc.) may have a permission to access the database 150. In some embodiments, one or more components in the on-demand service system 100 may read and/or modify information relating to the service requester, driver, and/or the public when one or more conditions are met. For example, the server 110 may read and/or modify one or more users' information after a service. As another example, the driver terminal 140 may access information relating to the service requester when receiving a service request from the user equipment 130, but the driver terminal 140 may not modify the relevant information of the service requester.

In some embodiments, information exchanging of one or more components in the on-demand service system 100 may be achieved by way of requesting a service. The object of the service request may be any product. In some embodiments, the product may be a tangible product, or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

One of ordinary skill in the art would understand that when an element of the on-demand service system 100 performs, the element may perform through electrical signals and/or electromagnetic signals. For example, when a user equipment 130 processes a task, such as making a determination, identifying or selecting an object, the user equipment 130 may operate logic circuits in its processor to process such task. When the user equipment 130 sends out a service request to the server 110, a processor of the user equipment 130 may generate electrical signals encoding the request. The processor of the user equipment 130 may then send the electrical signals to an output port. If the user equipment 130 communicates with the server 110 via a wired network, the output port may be physically connected to a cable, which further transmit the electrical signal to an input port of the server 110. If the user equipment 130 communicates with the server 110 via a wireless network, the output port of the user equipment 130 may be one or more antennas, which convert the electrical signal to electromagnetic signal. Similarly, a user equipment 130 may process a task through operation of logic circuits in its processor, and receive an instruction and/or service request from the server 110 via electrical signal or electromagnet signals. Within an electronic device, such as the user equipment 130, the driver terminal 140, and/or the server 110, when a processor thereof processes an instruction, sends out an instruction, and/or performs an action, the instruction and/or action is conducted via electrical signals. For example, when the processor retrieves or saves data from a storage medium, it may send out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and software components of a computing device 200 on which the server 110, the user equipment 130, and/or the driver terminal 140 may be implemented according to some embodiments of the present disclosure. For example, the processing engine 112 may be implemented on the computing device 200 and configured to perform functions of the processing engine 112 disclosed in this disclosure.

The computing device 200 may be a general purpose computer or a special purpose computer, both may be used to implement an on-demand system for the present disclosure. The computing device 200 may be used to implement any component of the on-demand service as described herein. For example, the processing engine 112 may be implemented on the computing device 200, via its hardware, software program, firmware, or any combination thereof. Although only one such computer is shown, for convenience, the computer functions relating to the on-demand service as described herein may be implemented in a distributed fashion on a number of similar platforms, to distribute the processing load.

The computing device 200, for example, may include COM ports 250 connected to and from a network connected thereto to facilitate data communications. The computing device 200 may also include a processor 220, in the form of one or more processors, for executing program instructions. The exemplary computer platform may include an internal communication bus 210, program storage and data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, RAM 240, and/or other type of non-transitory storage medium to be executed by the processor 220. The methods and/or processes of the present disclosure may be implemented as the program instructions. The computing device 200 also includes an I/O component 260, supporting input/output between the computer and other components therein. The computing device 200 may also receive programming and data via network communications.

The computing device 200 may also include a hard disk controller communicated with a hard disk, a keypad/keyboard controller communicated with a keypad/keyboard, a serial interface controller communicated with a serial peripheral equipment, a parallel interface controller communicated with a parallel peripheral equipment, a display controller communicated with a display, or the like, or any combination thereof.

Merely for illustration, only one CPU and/or processor is described in the computing device 200. However, it should be note that the computing device 200 in the present disclosure may also include multiple CPUs and/or processors, thus operations and/or method steps that are performed by one CPU and/or processor as described in the present disclosure may also be jointly or separately performed by the multiple CPUs and/or processors. For example, if in the present disclosure, the CPU and/or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

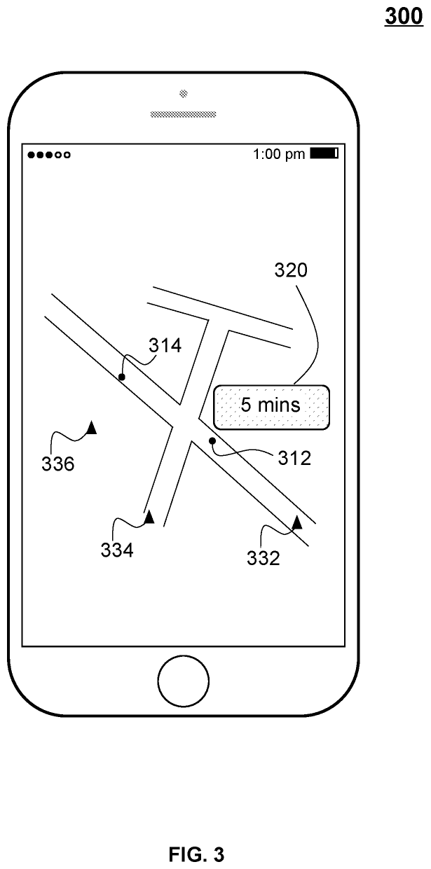

FIG. 3 is an exemplary user interface 300 on a terminal device of a servicer requester according to some embodiments of the present disclosure. The terminal device may be a user equipment (e.g., a mobile device, etc.). Referring to FIG. 3, the user interface 300 may illustrate one or more elements that are associated with a departure location icon 312.

The user interface 300 may include a departure location icon (e.g., a departure location icon 312, a departure location icon 314, etc.), a service provider icon (e.g., a service provider icon 332, a service provider icon 334, and a service provider icon 336), a road map, a message icon (e.g., a message icon 320), or the like, or any combination thereof.

The departure location icon may represent the departure location associated with a user (e.g., a passenger) operating a user equipment. The service provider icon may represent a location associated with a terminal device (e.g., the driver terminal 140) of a service provider (e.g., a taxi driver driving a taxi). The message icon may display an estimated time of arrival (ETA). In some embodiments, the message icon 320 may display the ETA in a form of time length (e.g., 5 mins, 10 mins) or in a form of exact time (e.g., 10:00 PM).

In some embodiments, a user may input and/or select a departure location on the user interface 300. For example, the user may select a location relating to the departure location icon 312 as a departure location. In some embodiments, an on-demand service system 100 may determine a location of the terminal device and display the location as a departure location on the user interface 300.

In some embodiments, a terminal device may receive data (e.g., an ETA) from a server (e.g., a server of the on-demand service system 100) and display the data on the user interface 300. The data may be displayed in a form of text, sound, figure, or the like, or any combination thereof. For example, an ETA may be displayed on the message icon 320 in the form of a number (e.g., 5) and a unit (e.g., mins) as shown in FIG. 3.

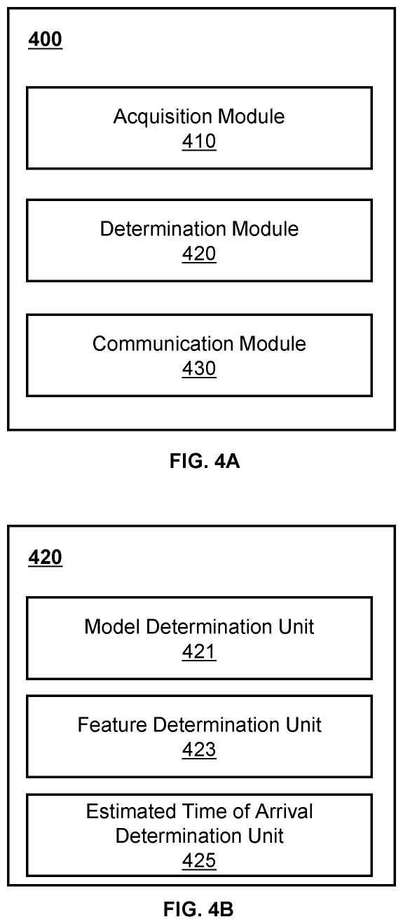

FIG. 4A is a block diagram of an exemplary processor 400 according to some embodiments of the present disclosure. The processor 400 may be implemented in the server 110, the user equipment 130, the driver terminal 140, and/or the database 150. The processor 400 may include an acquisition module 410, a determination module 420, and a communication module 430. FIG. 4B is a block diagram of an exemplary determination module 420 according to some embodiments of the present disclosure. The determination module 420 may include a model determination unit 421, a feature determination unit 423 and an estimated time of arrival determination unit 425.

Generally, the word “module” as used herein, refers to logic embodied in hardware or firmware, or to a collection of software instructions. The modules described herein may be implemented as software and/or hardware modules and may be stored in any type of non-transitory computer-readable medium or other storage device. In some embodiments, a software module may be compiled and linked into an executable program. It will be appreciated that software modules can be callable from other modules or from themselves, and/or can be invoked in response to detected events or interrupts. Software modules configured for execution on a computing device can be provided on a computer readable medium, such as a compact disc, a digital video disc, a flash drive, a magnetic disc, or any other tangible medium, or as a digital download (and can be originally stored in a compressed or installable format that requires installation, decompression, or decryption prior to execution). Such software code can be stored, partially or fully, on a memory device of the executing computing device, for execution by the computing device. Software instructions can be embedded in a firmware, such as an EPROM. It will be further appreciated that hardware modules can be included of connected logic units, such as gates and flip-flops, and/or can be included of programmable units, such as programmable gate arrays or processors. The modules or computing device functionality described herein are preferably implemented as software modules, but can be represented in hardware or firmware. In general, the modules described herein refer to logical modules that can be combined with other modules or divided into sub-modules despite their physical organization or storage.

The acquisition module 410 may be configured to obtain a departure location associated with a terminal device. The terminal device (e.g., the user equipment 130) may be configured to send a service request. The departure location may be a start location associated with a service request. The terminal device may be located at a current location. The departure location may be same or different with the current location of the terminal device.

In some embodiments, the departure location may be a current location associated with a terminal device (e.g., the user equipment 130). For example, the on-demand service system 100 may monitor a status (e.g., a using state of an application) of a terminal device and determine a current location of the terminal as the departure location based on the status.

In some embodiments, the departure location may be a pickup location a distance away from the current location associated with a terminal device (e.g., the user equipment 130). For example, the user may use a terminal to request a service for a friend that is different from the current location of the terminal device. Then the departure location may be a location of the friend.

In some embodiments, the departure location may be expressed as latitude and longitude coordinates (e.g., (N:34° 31′, E:69° 12′)) by using a Global Positioning System (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. In some embodiments, the departure location may be illustrated as a description of the location instead of the latitude and longitude coordinates, for example, McDonald store.

The acquisition module 410 may be configured to obtain information relating to a departure location. The information relating to the departure location may be time information, service provider information, order information, traffic information, or the like, or any combination thereof.

In some embodiments, the time information relating to the departure location may be a pickup time or a service request time. For example, at 5:30 pm, a user may input a departure location with a designated time that after 5:30 pm (e.g., 6:00 pm, etc.). As another example, the on-demand service system 100 may determine a current time associated with the departure location.

In some embodiments, the service provider information associated with the departure location may include a number of the service providers within the certain range of the departure location, vehicle information of the service providers (e.g., color of the vehicle, plate number of the vehicle, types of the vehicle, mileage rate of the vehicle, fuel consumption of the vehicle, and remaining oil of the vehicle), individual information of the service providers (e.g., age, driving years, and driver license number), or the like, or any combination thereof.

In some embodiments, the order information relating to the departure location may include historical order information, current order information, and potential order information associated with the departure location. For example, the order information may include a plurality of historical orders placed at the departure location or within a certain range of the departure location. As another example, the order information may include a plurality of orders placed with a time range from the current time at the departure location or within a certain range of the departure location. As yet another example, the order information may include a plurality of potential orders, in which the on-demand service app may be launched in the user terminals located near the departure location. The start location of the order and the departure location may be the same or different. For example, the order may be an order of which the start location is same with the departure location. As another example, the order may be an order of which the start location is in an area relating to the departure location (e.g., within a circle area with a radius of 50 meters centered at the departure location).

The order information may include time information (e.g., a pickup time, an arrival time of a service provider, a waiting time for a traffic light, and a traffic jam time), order distribution information, service provider information, service requester information, or the like, or any combination thereof. For example, historical order information associated with a historical order may include a historical arrival time for pickup, service provider information, historical departure location of the historical order, route information of the historical order, traffic information associated with the historical order.

In some embodiments, the traffic information relating to the departure location may include a number of traffic lights, a condition of road congestion, whether there is an accident or construction, or the like, or any combination thereof.

The determination module 420 may determine a trained machine learning model. In some embodiments, the trained machine learning model may be determined by the model determination unit 421. The trained machine learning model may be a supervised learning model, an unsupervised model, and a reinforcement learning model. The trained machine learning model may be a regression model, a classification model, and a clustering model. For example, the regression model may be a Factorization Machine (FM) model, a Gradient Boosting Decision Tree (GBDT) model, a Neural Networks (NN) model, or other deep learning model.

The determination module 420 may extract features from the information relating to the departure location. In some embodiments, the features may be extracted by the feature determination unit 423. In some embodiments, the extracted features may include location attribute, time attribute, order attribute, traffic attribute, or the like, or any combination thereof. The time attribute may be a historical arrival time for pickup, or a time period (e.g., a rush hour, an early morning, a midnight, etc.). The order attribute may be a number of orders, a density of orders in a selected area. The traffic attribute may be a number of traffic lights, a condition of road congestion.

The determination module 420 may determine an estimated time of arrival (ETA) for a service provider to arrive at the departure location. In some embodiments, the ETA may be determination by the estimated time of arrival determination unit 425. As used herein, the ETA may refer to a time for a service provider to drive from his/her current location to the pickup location (e.g., a departure location of a user). In some embodiments, the ETA may be a time length (e.g., 10 mins) for a service provider to arrival at a destination location (i.e., the waiting time of the service requester). In some embodiments, the ETA may be an exact time (e.g., 10:10 PM) at which a service provider may arrive.

The communication module 430 may be configured to send information to a terminal device (e.g., the user equipment 130). The information may be an ETA, service provider information, location information, or the like, or any combination thereof. For example, the communication module 430 may send a latitude and longitude data to the user equipment 130 to locate the user equipment 130 on a map. As another example, the communication module 430 may send an ETA to the user equipment 130 before the user places an order for a service.

The communication module 430 may be configured to receive information from a terminal device (e.g., the user equipment 130). For example, the communication module 430 may receive a location information form the user equipment 130. The location information may be a current location of the user equipment 130 or a location selected by a user. For example, the communication module 430 may receive an application using state information (e.g., whether an application is launched or not) from the user equipment 130.

It should be noted that the descriptions above in relation to processor 400 is provided for the purposes of illustration, and not intended to limit the scope of the present disclosure. For persons having ordinary skills in the art, various variations and modifications may be conducted under the guidance of the present disclosure. However, those variations and modifications do not depart the scope of the present disclosure. For example, part or all of the data acquired by processor 400 may be processed by the user equipment 130. As another example, there may be a training module (not shown in FIG. 4) and the training module may train a machine learning model. Similar modifications should fall within the scope of the present disclosure.

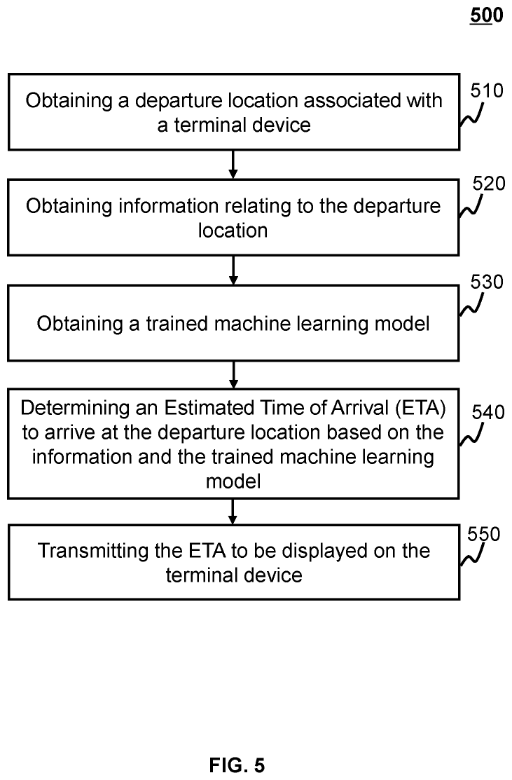

FIG. 5 is a flow chart of an exemplary process 500 for determining an ETA to arrive at a departure location according to some embodiments of the present disclosure. The process 500 may be performed by the on-demand service system 100 introduced in FIGS. 1-4. For example, the process 500 may be implemented as one or more instructions stored in a non-transitory storage medium of the on-demand system. When the processor 400 of the on-demand service system executes the set of instructions, the set of instructions may direct the processor 400 to perform the following s of the process.

In 510, the processor 400 (e.g., the acquisition module 410) may obtain a departure location associated with a terminal device (e.g., the user equipment 130). The departure location may be a location of the terminal device. The departure location may be a location select through the terminal device.

In some embodiments, the departure location may be input manually or selected from a plurality of records by a user of the terminal device. The plurality of records may include locations associated with the user (e.g., locations the user have been selected in the last week). In some embodiments, the user may determine the departure location by moving an icon (e.g., the departure location icon 312 as shown in FIG. 3) that represents the departure location.

In some embodiments, the processor 400 may obtain the departure location before a service request is determined by a user associated with the departure location. For example, when the user of the terminal launches an on-demand service application (e.g., DiDi ChuXing™) that installed in a terminal device, the acquisition module 410 may automatically obtain the current location of the terminal device (e.g., the user equipment 130).

In some embodiments, in 510, the processor 400 may interpret the current location to an address of the departure location, including a name of a mall, a road, an iconic landmark, a residential area, a mansion, a supermarket, or the like, or any combination thereof

In 520, the processor 400 (e.g., the acquisition module 410) may obtain information relating to the departure location. The information relating to the departure location may be time information, service provider information, order information, traffic information, or the like, or any combination thereof.

The service provider information may be information associated with the service providers who are located within an area relating to the departure location. For example, the area may be a circular area with a predetermined radius (e.g., 5 kilometers) centered at the departure location. As another example, the area may be a square area with a predetermined side length (e.g., 5 kilometers) centered at the departure location. The above examples of the area are for illustrative purpose and the present disclosure is not intended to be limiting. The area may be any of geometric shapes. Further, the area may be determined based on administrative divisions, for example, within Washington D.C. area.

The traffic information relating to the departure location may be traffic information of an area associated with the departure location.

In 530, the processor 400 may obtain a trained machine learning model.

The trained machine learning model may be trained to determine the ETA to arrive at the departure location before the user sends a service request. In some embodiments, the trained machine learning model may be a Factorization Machine (FM) model. The FM model may determine the ETA based on features that extracted from the information relating to the departure location. The model equation for the FM of degree d=2 is defined as:

$$\hat{y} ( x ) = {w}_{0} + {\sum }_{i = 1}^{n} {w}_{i} {x}_{i} + {\sum }_{i = 1}^{n} {\sum }_{j = i + 1}^{n} 〈 {v}_{i} , {v}_{j} 〉 {x}_{i} {x}_{j} \qquad ( 1 )$$

wherein, parameter w₀ is a global bias, x is a feature (e.g., xᵢ is the i-th feature, xⱼ is the j-th feature), parameter wᵢ is a strength of the i-th feature xᵢ, n is a number of the features, parameter [symbol] vᵢ,vⱼ [symbol] is the interaction between the i-th feature and j-th feature, and ŷ(x) is a final prediction result of the ETA. In the present disclosure, a process of training the FM model may be a process for determining parameters in equation (1). The FM model may also allow high quality parameter estimates of higher-order interactions (d≥2).

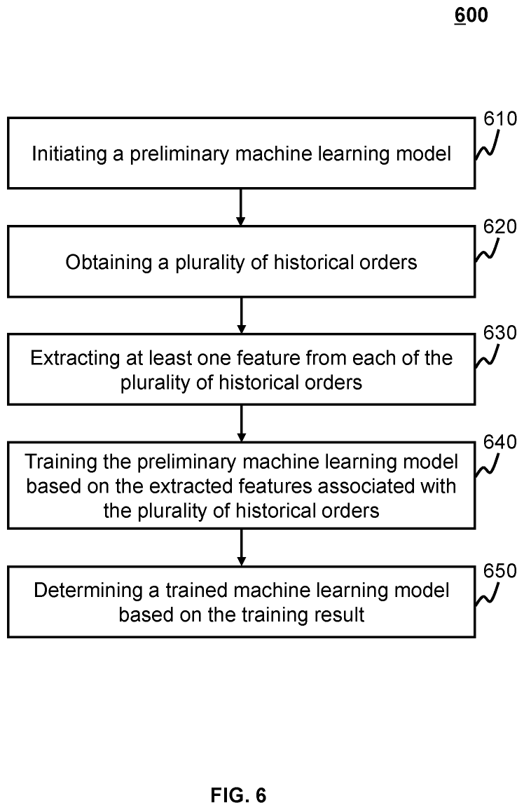

In some embodiments, the trained machine learning model may be a Gradient Boosting Decision Tree (GBDT) model. The gradient boosting may be a gradient descent algorithm. The GBDT modeling process may combine weak “learners” into a single strong learner, in an iterative fashion. At each stage 1≤m≤M of gradient boosting, there may be at least one imperfect model Fₘ. M is the number of features used in the GBDT model. In some embodiments, the gradient boosting algorithm may determine the model Fₘ by constructing a new model that adds an estimator h to provide a better model Fₘ₊₁=Fₘ(x)+h(x). Each Fₘ₊₁ may learn to correct its predecessor Fₘ in a negative gradient of a loss function. The greater the loss function is, the more likely the model Fₘ appears error. Detailed description about the process and/or method of determining the trained machine learning model will be illustrated in FIG. 6.

In 540, the processor 400 (e.g., the determination module 420) may determine an ETA to arrive at the departure location based on the information and the trained machine learning model.

In some embodiments, the processor 400 (e.g., the determination module 420) may extract at least one feature from the information relating to the departure location. The at least one feature may include location attribute (e.g., the departure location of a historical order), service provider attribute (e.g., a number of the service providers in an area), time attribute (e.g., a pickup time), traffic attribute (e.g., a number of traffic lights), or the like. The trained machine learning model may analyze the features. The processor 400 may determine the ETA to arrive at the departure location based on the analysis result. In some embodiments, the processor 400 may determine the ETA before receiving a service request from the terminal device (e.g., the user equipment 130).

In some embodiments, the trained machine learning model may compare current information associated with a departure location with a plurality of historical information extracted from historical orders associated with the departure location. Historical information of each of the plurality of historical orders may include a historical arrival time for pickup. The trained machine learning model may determine whether there is historical information matching the current information. In response to a determination that there is historical information matching the current information, the historical arrival time for pickup corresponding to the historical information may be used as a parameter to train the trained machine learning model.

In 550, the processor 400 (e.g., the communication module 430) may transmit the ETA to be displayed on the terminal device (e.g., the user equipment 130).

The terminal may display the ETA as an exact time (e.g., 10:10 am, 10:10 pm, or 23:11), (e.g., 5 minutes, or 2 minutes), or the like, or any combination thereof. For example, the ETA may be displayed in a form of text as shown in FIG. 3.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, some steps may be reduced or added. For example, one or more other options (e.g., a storing process) may be added elsewhere in the exemplary process/method 500. As another example, the processor 400 may extract the at least one features from the departure location and information associated with the departure in 520 or 530. Similar modifications should fall within the scope of the present disclosure.

FIG. 6 is a flow chart of an exemplary process 600 for determining a trained machine learning model according to some embodiments of the present disclosure. The process 600 may be performed by the on-demand service system introduced in FIGS. 1-4. For example, the process 600 may be implemented as one or more instructions stored in a non-transitory storage medium of the on-demand system. When the processor 400 of the on-demand service system executes the set of instructions, the set of instructions may direct the processor 400 to perform the following s of the process. In some embodiments, step 530 of process 500 may be performed based on process 600 for determining a trained machine learning model.

In 610, the processor 400 (e.g., the determination module 420) may initiate a preliminary machine learning model before training the learning model.

In 620, the processor 400 (e.g., the acquisition module 410) may obtain a plurality of historical orders. The processor 400 may obtain the plurality of historical orders from the user equipment 130, the driver terminals 140, or the database 150.

In some embodiments, the plurality of historical orders may be historical orders associated with an exact time or a same time period. The time period may be any length, for example, multiple years (e.g., recent three years, recent 2 years, etc.), a year (e.g., last year, current year, recent one year, etc.), half of a year (e.g., recent six months, the first half of current year, etc.), a quarter of a year (e.g., recent three months, the second quarter of current year, etc.), etc.

In some embodiments, the plurality of historical orders may be historical orders associated with an area relating to the departure location. Start locations of the historical orders may be in the area. For example, the plurality of historical orders may be history orders in Haidian district.

In some embodiments, the plurality of historical orders may be determined based on a condition. For example, the condition maybe that the service type associated with the plurality of historical orders is car-sharing. As another example, the condition maybe that the type of the vehicle associated with the plurality of historical orders is sport utility vehicle.

The historical orders may include historical information associated with the historical orders. The historical information associated with the historical orders may include historical location information (e.g., historical departure locations), historical time information (e.g., historical arrival time for pickup), historical order information (e.g., a historical number of orders), historical traffic information (e.g., a historical number of traffic lights), etc. The historical information associated with the historical orders may be obtained from the historical orders and data that stored in the database 150.

In 630, the processor 400 (e.g., the determination module 420) may extract at least one feature from each of the plurality the historical orders. The at least one feature may include the location attribute, the time attribute, order attribute, traffic attribute, etc. The at least one feature may also include a historical number of service providers before each of the historical orders is made a deal.

In some embodiments, the processor 400 may extract at least one feature from historical information associated with each of the plurality the historical orders.

In 640, the processor 400 (e.g., the determination module 420) may train the preliminary machine learning model based on the extracted features associated with the plurality of historical orders.

The extracted features may be input to the initiated preliminary machine learning model. The initiated machine learning may analyze the extracted features to modify the parameters of the initiated machine learning.

In some embodiments, the extracted features extracted from the historical information may generate historical feature data corresponding to each of the historical information. The processor 400 may use the historical feature data in different groups for different stages in step 640 and/or 650. For example, the processor 400 may use the historical feature data to train and/or test the preliminary machine learning model.

In 650, the processor 400 (e.g., the determination module 420) may determine a trained machine learning model based on the training result.

In some embodiments, the determination process may include determining whether the trained machine learning model satisfies a converging condition. The converging condition may include determining whether an error is less than a threshold value. For example, the processor 400 may select some of the historical feature data obtained in 640 as a testing data. The testing data may be historical feature data that is not used in training the preliminary machine learning model in 640. The processor 400 may determine an ETA based on the testing data. Then the processor 400 may determine the error based on the ETA determined by the trained machine learning model and historical arrival time for pickup in the testing data. In response to a determination that the error is less than the threshold value, the processor 400 may determine the trained machine learning model in 650. In response to determining that the error is not less than the threshold value, the processor 400 may go back to 630 again.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, some steps may be reduced or added. For example, one or more other options (e.g., a storing process) may be added elsewhere in the exemplary process/method 600. As another example, the processor 400 may initiate a preliminary machine learning model in 640. Similar modifications should fall within the scope of the present disclosure.

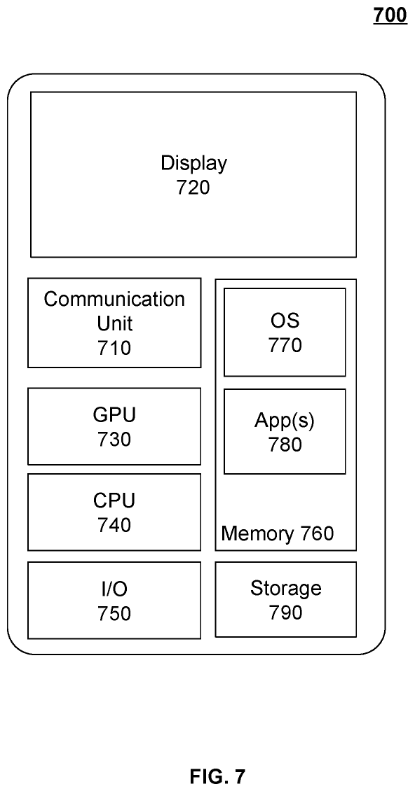

FIG. 7 is a schematic diagram illustrating exemplary hardware and/or software components of an exemplary mobile device 700 on which the user equipment 130 or the driver terminal 140 may be implemented according to some embodiments of the present disclosure. As illustrated in FIG. 7, the mobile device 700 may include a communication platform 710, a display 720, a graphic processing unit (GPU) 730, a central processing unit (CPU) 740, an I/O 750, a memory 760, and a storage 790. In some embodiments, any other suitable component, including but not limited to a system bus or a controller (not shown), may also be included in the mobile device 700. In some embodiments, a mobile operating system 770 (e.g., iOS™, Android™, Windows Phone™, etc.) and one or more applications 780 may be loaded into the memory 760 from the storage 790 in order to be executed by the CPU 740. The applications 780 may include a browser or any other suitable mobile apps for receiving and rendering information relating to monitoring an on-demand service or other information from, for example, the processing engine 112. User interactions with the information stream may be achieved via the I/O 750 and provided to the processing engine 112 and/or other components of the on-demand service system 100 via the network 120.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C #, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purposes of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

We claim:

1. A system comprising:
at least one computer-readable storage medium including a set of instructions for managing supply of services; and
at least one processor in communication with the at least one storage medium, wherein when executing the set of instructions, the at least one processor is directed to:
operate logical circuits in the at least one processor to obtain a departure location associated with a terminal device;
operate the logical circuits in the at least one processor to obtain information relating to the departure location, the information including information of one or more service providers;
operate the logical circuits in the at least one processor to obtain a trained machine learning model; and
operate the logical circuits in the at least one processor to determine an estimated time of arrival for the one or more service providers to arrive at the departure location based on the information and the trained machine learning model.

2. The system of claim 1, the at least one processor is further directed to:
operate the logical circuits in the at least one processor to transmit the estimated times of arrival corresponding to the one or more service providers to be displayed on the terminal device.

3. The system of claim 1, wherein the information relating to the departure location further comprises at least one of
a number of the one or more service providers,
vehicle types associated with the one or more service providers,
driver profiles associated with the one or more service providers,
an order distribution associated with the departure location, or
traffic information associated with the departure location.

4. The system of claim 1, wherein the trained machine learning model is determined by performing:
operating the logical circuits in the at least one processor to initiate a preliminary machine learning model;
operating the logical circuits in the at least one processor to obtain a plurality of historical orders;
operating the logical circuits in the at least one processor to extract at least one feature from each of the plurality of historical orders;
operating the logical circuits in the at least one processor to train the preliminary machine learning model based on the extracted features associated with the plurality of historical orders; and
operating the logical circuits in the at least one processor to determine the trained machine learning model based on the training result.

5. The system of claim 4, wherein the at least one feature comprises at least one of
time attribute,
location attribute,
order attribute, or
traffic attribute.

6. The system of claim 4, wherein the plurality of historical orders are historical orders associated with an area relating to the departure location.

7. The system of claim 1, the machine learning model includes a Factorization Machine (FM) model, a Gradient Boosting Decision Tree (GBDT) model or a Neural Networks (NN) model.

8. A method implemented on at least one device each of which has at least one processor, storage and a communication platform to connect to a network, the method comprising:
operating logical circuits in the at least one processor to obtain a departure location associated with a terminal device;
operating the logical circuits in the at least one processor to obtain information relating to the departure location, the information including one or more service providers;
operating the logical circuits in the at least one processor to obtain a machine learning model; and
operating the logical circuits in the at least one processor to determine an estimated time of arrival for the one or more service providers to arrive at the departure location based on the information and the machine learning model.

9. The method of claim 8, the method further comprising:
operating the logical circuits in the at least one processor to transmit the estimated times of arrival corresponding to the one or more service providers to be displayed on the terminal device.

10. The method of claim 8, wherein the information relating to the departure location further comprises at least one of
a number of the one or more service providers,
vehicle types associated with the one or more service providers,
driver profiles associated with the one or more service providers,
an order distribution associated with the departure location, or
traffic information associated with the departure location.

11. The method of claim 8, wherein the trained machine learning model is determined by performing:
operating the logical circuits in the at least one processor to initiate the machine learning model;
operating the logical circuits in the at least one processor to obtain a plurality of historical orders;
operating the logical circuits in the at least one processor to extract at least one feature from each of the plurality of historical orders;
operating the logical circuits in the at least one processor to train the machine learning model based on the extracted features associated with the plurality of historical orders; and
operating the logical circuits in the at least one processor to determine the machine learning model based on the training result.

12. The method of claim 11, wherein the at least one feature comprises at least one of
time attribute,
location attribute,
order attribute, or
traffic attribute.

13. The method of claim 11, wherein the plurality of historical orders are historical orders associated with an area relating to the departure location.

14. The method of claim 8, the machine learning model includes a Factorization Machine (FM) model, a Gradient Boosting Decision Tree (GBDT) model or a Neural Networks (NN) model.

15. A non-transitory computer readable medium comprising executable instructions that, when executed by at least one processor, cause the at least one processor to effectuate a method comprising:
operating logical circuits in the at least one processor to obtain a departure location associated with a terminal device;
operating the logical circuits in the at least one processor to obtain information relating to the departure location, the information including one or more service providers;
operating the logical circuits in the at least one processor to obtain a machine learning model; and
operating the logical circuits in the at least one processor to determine an estimated time of arrival for one of the one or more service providers to arrive at the departure location based on the information and the machine learning model.

16. The non-transitory computer readable medium of claim 15, the at least one processor is further directed to:
operate the logical circuits in the at least one processor to transmit the estimated times of arrival corresponding to the one or more service providers to be displayed on the terminal device.

17. The non-transitory computer readable medium of claim 15, wherein the information relating to the departure location further comprises at least one of
a number of the one or more service providers,
vehicle types associated with the one or more service providers,
driver profiles associated with the one or more service providers,
an order distribution associated with the departure location, or
traffic information associated with the departure location.

18. The non-transitory computer readable medium of claim 15, wherein the trained machine learning model is determined by performing:
operating the logical circuits in the at least one processor to initiate a preliminary machine learning model;
operating the logical circuits in the at least one processor to obtain a plurality of historical orders;
operating the logical circuits in the at least one processor to extract at least one feature from each of the plurality of historical orders;
operating the logical circuits in the at least one processor to train the preliminary machine learning model based on the extracted features associated with the plurality of historical orders; and
operating the logical circuits in the at least one processor to determine the trained machine learning model based on the training result.

19. The non-transitory computer readable medium of claim 15, wherein the at least one feature comprises at least one of
time attribute,
location attribute,
order attribute, or
traffic attribute.

20. The non-transitory computer readable medium of claim 15, wherein the plurality of historical orders are historical orders associated with an area relating to the departure location.
